(19) United States
(12) Patent Application Publication
(10) Pub. No.: US 2012/0318721 A1
(43) Pub. Date: Dec. 20, 2012

(54) GROOVED SCREEN USED IN A TRAMP MATERIAL SEPARATOR

(76) Inventor: Brian J. Gallagher, Litchfield, NH (US)

(21) Appl. No.: 13/164,030

(22) Filed: Jun. 20, 2011

(51) Int. Cl. D21D 5/00; D21D 5/16; B03B 5/56; B07B 1/18

(52) U.S. Cl. 209/273

(57) ABSTRACT

A screen cylinder for screening papermaker's stock, the screen cylinder having slots over substantially all of the screen, and blind grooves in at least one of the screen cylinder surfaces, the grooves extending along that surface at an angle to the slots.

### BACKGROUND

This disclosure relates to a screen used in a tramp material separator for removing heavy debris from a pulp suspension.

Heavy debris (i.e. nuts, bolts, etc.) can cause damage to equipment in a mill. A tramp material separator in the pulp feed line gives protection against damage caused by heavy debris in pulp suspensions at consistencies up to 7%. The incoming pulp flow passes through a slotted screen in the tramp material separator to separate out the heavy debris.

The pulp flow passes from outside to inside of the screen cylinder through the slots and then leaves at the accept side of the screen and housing. The debris that cannot pass through the slots stays on the outside. The debris is removed in a vertical trap attached to the bottom connection of the separator. A flow of dilution to the trap recovers any fibers. Closing the upper valve and opening the lower one for a short time removes the debris from the system.

The current tramp material separator is configured horizontally. The entry is radial, while the discharge is axial at 90 degrees to the entry. The tramp material collection is in a chamber at the bottom. Pulp at between 1.0% and 7% consistency comes in the entry and passes through the cylindrical screen slotted openings that are perpendicular to the longitudinal axis of the cylindrical screen (e.g. circumferential slots). Accepted pulp stock leaves through a connection that is coaxial with the cylindrical screen.

The screen is built up of a number of adjacent rings with slots between them. The desired spacing between adjacent rings can be maintained by welding or otherwise affixing to the inlet face of the cylindrical screen defined by the rings elongated, axially extending bars, which not only serve to fix the rings in position, but also to reinforce the entire screen. In the alternative, the cylindrical screen can be fabricated by grinding or laser cutting the slots into a cylinder, or a sheet that is then rolled into a cylinder, or by other conventional methods.

In a conventional tramp material separator, the screen cylinder is attached to the housing at an outlet flange. A rotating cleaning device, between the housing and the screen cylinder, has two bars which may have cleaning fingers pointing inward radially between the screen rings. The cleaning device sweeps the outside of the screen, and if so equipped, the fingers keep the slots open. The cleaning device is connected to the rotating shaft at the driven end that is opposite the discharge. The cleaning fingers are the reason most tramp separator screens have the circumferential slots, at 90 degrees to the axis of the screen. Cylindrical screens used later for further reject separation most often have axial slots aligned with the axis of the screen, and rely on foils to generate turbulence adjacent the screen to clear the material away from the screen.

It has been known in the art to augment the separating ability of such axial slot cylinders by providing one or more blind grooves, parallel to the slots, in the outer radial (inlet) surface of the cylinders. The blind grooves create a turbulent boundary layer that breaks up pulp flocs and allows individual fibers to flow through the slots.

When the slots and the grooves are in the same direction, a two-dimensional flow field develops. In other words, you could take a slice section perpendicular to the axis of the cylindrical screen, and the streamlines you would see would be the same regardless of where that slice was taken. The flow mechanics of this arrangement are well understood to the microscopic level.

A tramp material separator circumferential slot cylindrical screen on the other hand conventionally has a smooth surface on the inlet (outer) side. When operating with small slots (1.5 to 2.0 mm wide) on long-fibered pulps, a problem has been experienced with plugging of the machine. This plugging occurs because there is insufficient deflocculation energy present to break the pulp flocs up sufficiently to pass through the small slots. Larger slots, or operation on shorter fibers, do not present the same problem because less deflocculation energy is required to permit pulp passage.

### SUMMARY

It is an object of this disclosure to provide a tramp material separator screen cylinder that allows long-fiber passage through fine slots while reducing plugging of the machine.

Accordingly, this disclosure provides a cylindrical screen for screening papermaker's stock, the cylindrical screen having slots over substantially all of the screen, and blind grooves in at least one of the cylindrical screen surfaces, the grooves extending along that surface at an angle to the slots.

When the slots and the grooves are an angle, a 3-D flow field is created. You no longer have the ability to disrupt the flow over the slots directly, since the irregular surface is to the sides of the slots. The spiral grooving more effectively influences the slots to either side of the land areas.

### BRIEF DESCRIPTION OF THE DRAWINGS

FIG. 1 is a schematic illustration of a portion of a pulping system with a tramp material separator according to this disclosure.

FIG. 2 is a partially broken away perspective view of the tramp material separator of FIG. 1.

FIG. 3 is an enlarged perspective view of part of one embodiment of the accept (outer) side of the cylindrical screen shown in FIG. 2.

FIG. 4 is an enlarged perspective view of part of a second embodiment of the accept (outer) side of the cylindrical screen shown in FIG. 2.

FIG. 5 is an enlarged perspective view of part of a third embodiment of the accept (outer) side of the cylindrical screen shown in FIG. 2.

Before one embodiment of the disclosure is explained in detail, it is to be understood that the disclosure is not limited in its application to the details of the construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Further, it is to be understood that such terms as “forward”, “rearward”, “left”, “right”, “upward” and “downward”, etc., are words of convenience and are not to be construed as limiting terms.

### DESCRIPTION OF THE PREFERRED EMBODIMENT

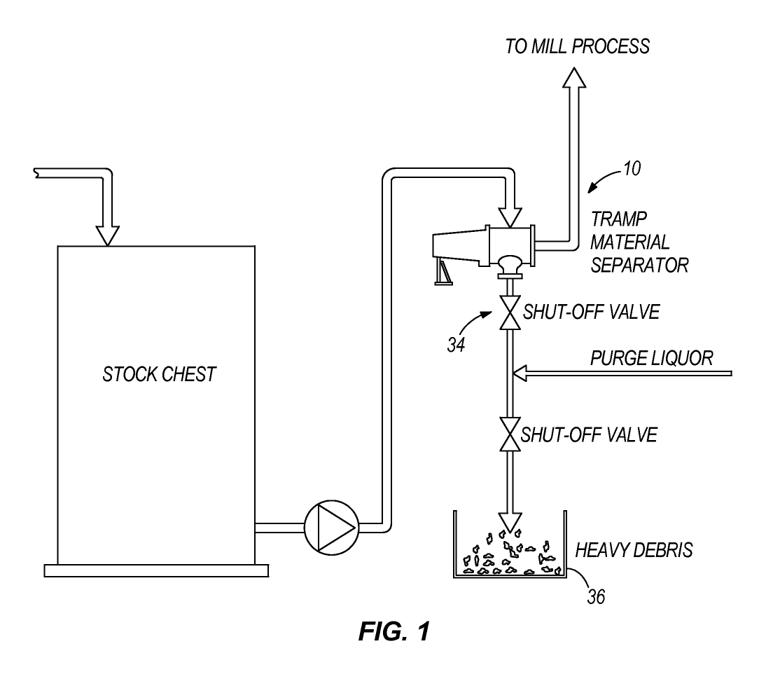

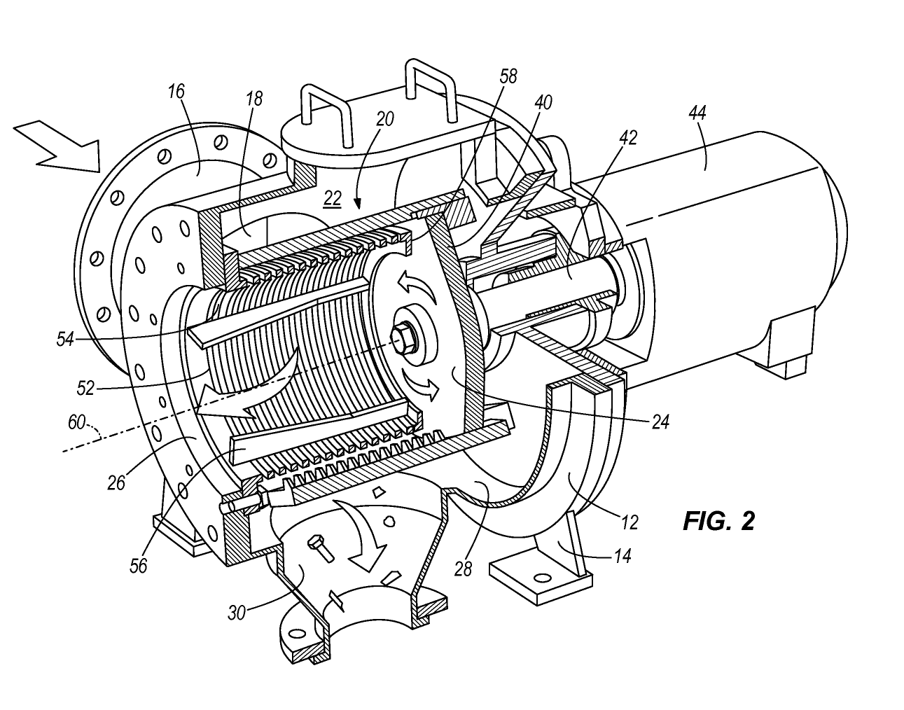

Illustrated in FIGS. 1 through 5 is a pulp mill process according to this disclosure. As shown in FIG. 1, the pulp mill process includes a tramp material separator or screening apparatus 10 that includes a main housing 12, as shown in FIG. 2, on a base 14 having an inlet chamber 16 on an outer surface of the housing with an inlet port 18 through which the paper making stock is fed under pressure into the main housing 12.

A cylindrical screen 20 is positioned within the housing such that it divides the housing into an outer chamber 22 into which the stock is initially fed, and an accepts chamber 24 communicating with an outlet port 26.

A bottom wall 28 of the chamber 22 has a trough 30 communicating with a discharge port 32 controlled by a valve assembly 34 that, as is conventional, is open in normal operation. A second valve assembly lower down is normally closed, leaving a volume of pipe between the two valves. The volume collects reject particles that drop from the trough 30. Periodically, at time intervals determined by the amount of rejectable material, the upper valve assembly 34 is closed, and the lower valve assembly is opened, allowing the rejectable material to fall into a collection box 36. After a short time, the two valves are returned to their normal state.

A rotating cleaning device 40, like the one described above, is supported on a drive shaft 42 in the supply chamber and is driven by means of a motor 44 and suitable interconnecting gearing or the like.

As best seen in FIGS. 2 through 5 of the drawings, the screen 20 includes a series of rings 52 which can conveniently be formed from generally triangularly cross-sectioned steel annular discs. To manufacture the cylindrical screen 20, the rings 52 are laid up in a suitable jig (not shown) that permits the rings 52 to be spaced as necessary to provide slots 54 of the de-sired width. Thereafter bars 56 are secured to the inner face of the cylindrical screen 20 by welding or the like and mounting rings 58 (only one is shown in FIG. 2) secured to the upper and lower ends of the screen 20. The resulting structure is the screen having the slots 54 normally disposed with respect to a longitudinal axis 60 of the screen 20 and of from 1.0 to 6.0 mm in width at their narrowest point, with the bars 56 projecting inwardly of the inner face of the screen 20.

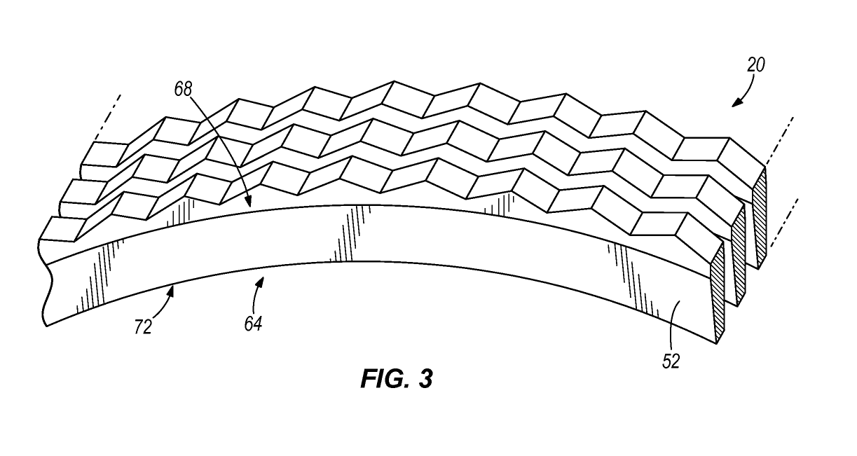

More particularly, as shown in FIG. 3, the rings 52 define a wall 64 having an outer radial surface 68 and an inner radial surface 72, and the wall 64 has the circumferential slots 54 over substantially the entire wall 64. The circumferential slots 54 extend along the wall at about a 90-degree angle to a plane (not shown) passing through the longitudinal axis 60. The circumferential slots 54 extend through the wall 64 from the outer surface 68 to the inner surface 72. In other embodiments (not shown), the inlet side of the screen 20 can be on the inner radial surface of the cylindrical screen.

The inlet (outer) side or surface 68 of the cylindrical screen 20 includes means for assisting in disrupting pulp flocs adjacent the circumferential slots 54, to encourage pulp passage through the slots. More particularly, the cylindrical screen wall 64 includes blind grooves 80 in its outer surface 68, the grooves 80 extending along the wall 64 at an angle to the circumferential slots 54. A blind groove 80 as defined herein means a groove that does not extend from the wall outer surface 68 to the wall inner surface 72.

The blind grooves can assume an infinite variety of shapes. For example, the grooves 80 are V-shaped, as shown in FIGS. 3 through 5, but in less preferred embodiments (not shown), the blind grooves could have parallel walls, and a bottom extending at a right angle to the parallel walls.

In the embodiment of FIG. 3, the grooves 80 comprise a set of spaced-apart grooves extending at a first angle (90 degrees) relative to the circumferential slots 54. In another embodiment (not shown), the set of blind grooves can extend at an angle of less than or more than 90 degrees, thus creating spirals on the inlet side of the cylindrical screen. This is advantageous if it would be useful to encourage debris to move toward one end of the cylindrical screen.

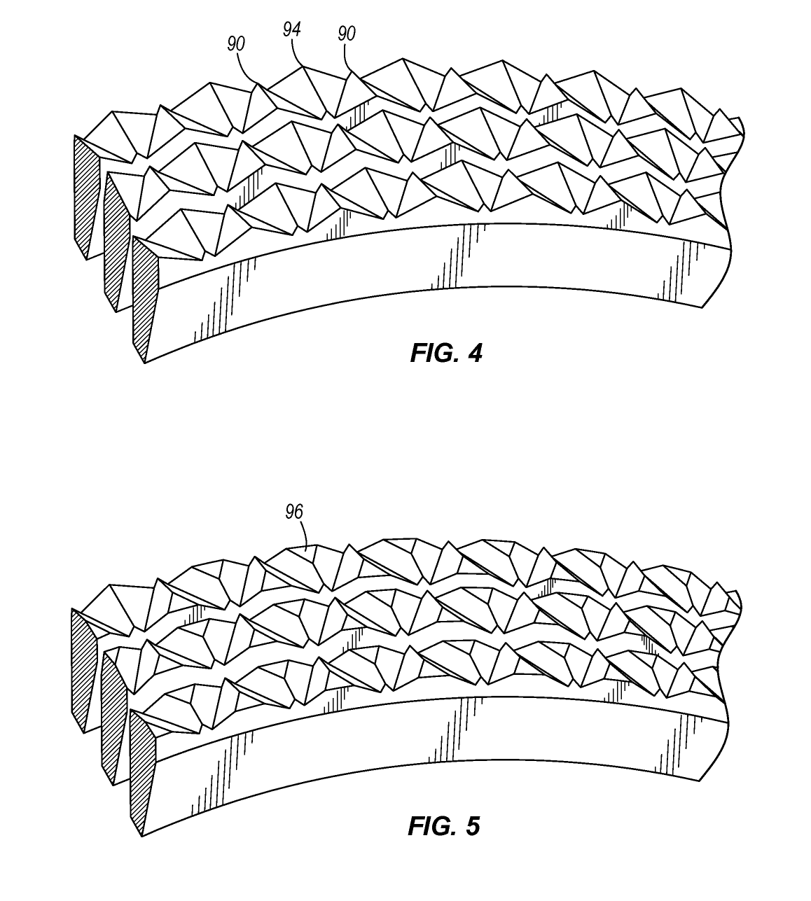

In other embodiments, as shown in FIGS. 4 and 5, the grooves 80 comprise a first set 90 of spaced-apart grooves extending at a first angle relative to the circumferential slots, and a second set 94 of spaced-apart grooves extending at a second angle, different than the first angle, relative to the circumferential slots 54.

More particularly, the first set 90 of grooves extends at an angle of less than 90 degrees relative to the circumferential slots 54, and the second set of grooves extends at an angle of more than 90 degrees relative to the circumferential slots 54.

The blind grooves 80 are relatively shallow, so they create some movement in the flow in the radial direction with respect to the cylindrical screen, but not stop the circumferential motion of the pulp. The embodiments illustrated have peaks not less than 0.5 mm high but not more than 2.0 mm high, and the pitch would be between 6 and 30 mm in the circumferential direction.

In one embodiment, as shown in FIG. 4, the shallow V-shaped grooves are set in a series of spirals at approximately 45 degrees from the circumferential slots 54. There are two such spiral sets with the spirals in opposite directions. The resulting surface pattern exhibits diamond-shaped projections 90, similar to the pattern known as “knurling” used on metal handholds. The peaks of the diamonds are located directly over the slots 54, and the resulting geometry encourages movement not only in the radial direction with respect to the cylindrical screen, but also in the axial direction. This embodiment uses full height grooves that necessarily meet in a sharp peak. In another and more preferred embodiment, spiraling shallow V-shaped grooves are used, but they do not meet in a peak, but rather have a plateau surface 94 between said grooves. This has advantages for wear resistance.

Various other features of this disclosure are set forth in the following claims.

1. A screen cylinder for screening papermaker's stock, said screen cylinder having a longitudinal axis, said screen cylinder including
a wall having an outer radial surface and an inner radial surface, said wall having circumferential slots over substantially all of said wall, said circumferential slots extending along said wall at about a 90 degree angle to a plane passing through said longitudinal axis, said circumferential slots extending through said wall from said outer surface to said inner surface, and
blind grooves in at least one of said screen cylinder surfaces, said grooves extending along said wall at an angle to said circumferential slots.

2. A screen cylinder in accordance with claim 1, wherein said blind grooves are in said screen cylinder outer radial surface.

3. A screen cylinder in accordance with claim 2, wherein said grooves comprise a first set of spaced-apart grooves extending at a first angle relative to said circumferential slots, and a second set of spaced-apart grooves extending at a second angle, different than said first angle, relative to said circumferential slots.

4. A screen cylinder in accordance with claim 3, wherein said first set of grooves extends at an angle of less than 90 degrees relative to said circumferential slots, and wherein said second set of grooves extends at an angle of more than 90 degrees relative to said circumferential slots.

5. A screen cylinder in accordance with claim 1, wherein said grooves are V-shaped.

6. A screen cylinder in accordance with claim 1, wherein said blind grooves intersect over said circumferential slots.

7. A screen cylinder in accordance with claim 1, wherein said blind grooves are shallow grooves leaving plateaus between said grooves.

8. A screen cylinder for screening papermaker's stock, said screen cylinder having a longitudinal axis, said screen cylinder including
a wall having an outer radial surface and an inner radial surface, said wall having circumferential slots over substantially all of said wall, said circumferential slots extending along said wall at about a 90 degree angle to a plane passing through said longitudinal axis, said circumferential slots extending through said wall from said outer surface to said inner surface, and
V-shaped blind grooves in said screen cylinder outer radial surface, said grooves comprising a first set of spaced-apart grooves extending at an angle of less than 90 degrees relative to said circumferential slots, and a second set of spaced-apart grooves extending at an angle of more than 90 degrees relative to said circumferential slots, said grooves intersecting over said circumferential slots and leaving plateaus between said grooves.

9. A screen cylinder for screening papermaker's stock, said screen cylinder having a longitudinal axis, said screen cylinder including a wall defining an outer radial surface and an inner radial surface, said wall having slots over substantially all of said wall, said slots extending through said wall from said outer surface to said inner surface, and
blind grooves in at least one of said screen cylinder surfaces, said grooves extending along said wall at an angle to said slots.
